(19) United States
(12) Patent Application Publication
(10) Pub. No.: US 2010/0050880 A1
(43) Pub. Date: Mar. 4, 2010

(54) DEVICE AND METHOD FOR SEPARATING CONTENTS AND PACKAGE OF A CAPSULE

(75) Inventors: Juerg Suter, Zurich (CH); Beat Zobrist, Zurich (CH); Stephan Villiger, Zurich (CH)

Correspondence Address: MCCORMICK, PAULDING & HUBER LLP, CITY PLACE II, 185 ASYLUM STREET, HARTFORD, CT, 06103, US

(73) Assignee: insent GmbH, Zug (CH)

(21) Appl. No.: 12/548,483

(22) Filed: Aug. 27, 2009

(30) Foreign Application Priority Data
Aug. 28, 2008 (CH) 1379/08

(51) Int. Cl. A47J 31/44; B30B 1/04; B30B 9/00

(52) U.S. Cl. 99/284; 100/39; 100/91; 100/94

(57) ABSTRACT

For separating the contents from the package of used capsules (10) for making beverages, particularly capsules of metal containing coffee, an device (1) respectively a press, particularly a manual press, is preferably used, by which the capsule is crunchable, such that its contents comes out of the extraction side of the capsule, where it is collected and can be disposed of separately from the capsule.

### CROSS REFERENCE TO RELATED APPLICATIONS

This application claims the priority of Swiss patent application No. 01379/08, filed Aug. 28, 2008, the disclosure of which is incorporated herein by reference in its entirety.

### BACKGROUND OF THE INVENTION

The invention is related to a device and a method for separating the contents and the package of used capsules which have been used for the preparation of beverages. Furthermore, the invention is related to a press as well as a coffee machine.

### PRIOR ART

It is known to use capsules for the preparation of beverages, particularly the preparation of coffee, containing a contents which is extractable by means of water, and thus especially containing ground coffee, which remains at least partially in the capsule after its usage or in other words after the making of the coffee. The capsules can be made of metal, which is especially advantageous for the conservation of ground coffee contained therein. Such capsules are for example known under the trademark Nespresso®. The embodiment of the capsule of metal makes a reuse of this material desirable, however, the contents remaining in the used capsule after making the beverage may be annoying for the reuse of the metal. Therefore, the manufacturers of such capsules offer recycling collection sites and a central recycling, wherein a big number of capsules are being shredded and metal and coffee grounds are being separated by means of known method steps like sieving.

### BRIEF SUMMARY OF THE INVENTION

It is the task of the invention to provide a further possibility for users of capsules to deliver these to the recycling after use.

This task is solved by a device for the capsule by capsule separation of the contents and of the package material of used capsules for the making of beverages, said device being adapted for at least partly destroying the capsules so that a large part of the coffee grounds are separated from the package material.

In particular the device is adapted to destroy the capsule by compressing or crunching and/or cutting open and/or puncturing at least a part of the capsule. Because the device for separating capsule material of the package from the contents of the capsule is intended for and adapted for in such a way that the separation takes place for each capsule separately or piece by piece, respectively, (but wherein several capsules can as well be separable at the same time but each one separately, the separation of individual capsules in package and contents after their use, particularly at home or at the office, can be carried out by the user in a simple way. Thereafter, the package can be delivered to the metal recycling in a known way and the contents can be disposed of separately, in the case of coffee grounds for example can also be composted. The invention provides for a separate, manually actuatable device for the home and office area, or for the incorporation into the machine making the beverage, thus particularly into a coffee machine. The device is adapted for the at least partial destruction of the capsule, in order to thereby separate the contents of the used capsule from the capsule material. Compressing or crunching, a cut to open or a puncture of at least a part of the capsule is meant by at least partial destruction.

In a first preferred embodiment of the device, it is executed in such a way, that the capsule is compressed at least partially above an opening of the device by means of a crunching means, whereby the contents of the capsule comes out through the opening while the capsule remains above the opening, such that a separation of capsule and contents takes place. This can be executed in different ways for manual or motor-driven actuation and both as separate device or device within a beverage making machine, especially a coffee machine. Within a preferred embodiment, a base having an intake which is intended for holding the capsule in a predefined position above the opening is provided, as well as a crunching means located above the base, by which the crunching force can be applied to a capsule located in position onto the base. This embodiment is equally suitable for a simple manual device and can form the basis for a device within a coffee machine. The opening is preferably arranged respectively dimensioned in such a way, that the capsule is held solely alongside its edge. This yields an as good as possible emptying of the capsule. It became evident that it is preferable to execute the opening with a side wall which enlarges in a conic way towards the capsule, facilitating the taking out of the destroyed, particularly crunched capsule.

In a preferred embodiment the crunching means is pivotable around an axis and is particularly arranged in a pivotable way at the base, also yielding a simple assembly, particularly if the crunching means is arranged or formed by an arm which is formed in one piece with the base. It is particularly preferred that the crunching means or crunching arm is provided with a crunching body which is substantially formed by a part of a body of revolution. The crunching body can particularly be formed by a part of a paraboloid. In such embodiments, the crunching body is particularly intended for and shaped such as to crunch for example a round cavity into the capsule, and particularly intended and dimensioned to form a crater-shaped cavity into the capsule, wherein its side walls remain partially undeformed as crater walls. It has become evident that a sufficient emptying of a capsule by a small effort by the user of the device is possible by means of such a pressing in of the back side of the capsule into the capsule and at the same time leaving the side wall of the capsule at least partially in place. This is particularly suitable for i.e. Nespresso® capsules, which are impinged by the crunching body from the water inlet side. The effort or necessary force is particularly to be considered within an device which is handled manually and whereby, because of lack of space and for a simple construction only a small lever for the hand force is provided, and particularly also if the device is formed for accommodating more than one capsule at the same time, particularly for two capsules. Depending on the available force, a crunching of substantially the entire capsule can occur and the crunching body can also be formed in a different way, and can for example be a simple plate-shaped part.

Within an embodiment, a cutting means is provided at the base and particularly at the intake, being intended for forming a partially or entirely circular cut into the capsule, enhancing the crunching and the emptying. Within an embodiment, the crunching means can have at least a positioning element which is intended for adjusting the mutual position of capsule and crunching means respectively for avoiding an evasion of the capsule during the crunching. Within a preferred embodiment, a removal aid for the destroyed capsule is provided, particularly in combination with the opening with conic side wall. The removal aid can be formed as spring means which presses the destroyed capsule out of its intake and/or the removal aid can be provided as recess which facilitates the taking out of the destroyed capsule from the intake.

For a simple operation of an device which is actuated manually, it can have a flat base for the positioning of the device onto a surface, for example on a table, wherein the opening is disposed at a distance from the surface, particularly by forming a collecting space, particularly a container, for receiving the contents of at least a capsule. The container has preferably provided with a closure. Furthermore, the device can have an opening, for example at the joint between base and crunching means, which allows a hanging of the device to a hook for its storage during non-use.

Instead of the preferred crunching of the capsule, the separation of package and contents can for example be provided as well by a pulling out of the contents by means of a spiral conveying means and/or by means of a striking means or vibrating means or by means of a detergent for flushing out the contents with water or by means of a blowing means and/or a sucking means. All embodiments of the device can be formed as separate devices or be arranged within a beverage making machine, particularly a coffee machine.

Thus, the invention is also related to a coffee machine with a device for separating package and contents of a used capsule.

Furthermore, the task is solved by using a press for the separation of package and contents.

Furthermore the task is solved by means of the method in which a single capsule is positioned with its extraction side above an opening and is at least partly destroyed, and particularly impinged upon and crunched by a crunching means from the side of intended water ingress into the capsule when extracting a beverage therefrom, such that at least a part of the contents of the capsule exits out of the capsule and falls through said opening.

### BRIEF DESCRIPTION OF THE DRAWINGS

The invention will be better understood and objects other than those set forth above will become apparent when consideration is given to the following detailed description thereof. Such description makes reference to the annexed drawings, which show:

FIG. 1 a graphical view of an embodiment of a device to which the invention relates;

FIG. 2 a side view of the device of FIG. 1;

FIG. 3 a graphical view of a further embodiment of the device;

FIG. 4 a side view of the device according to FIG. 3;

FIG. 5 a graphical view of an example of the device with cutting means;

FIG. 6 a vertical sectional view of the device of FIG. 5;

FIG. 7 a graphical view of an embodiment with removal aid;

FIG. 8 a vertical sectional view of the embodiment of FIG. 7;

FIG. 9 a graphical view of an embodiment with positioning means at the crunching body;

FIG. 10 a further embodiment in side view;

FIG. 11 a further embodiment in graphical view;

FIG. 12 a further embodiment in graphical view;

FIG. 13 the embodiment of FIG. 12 in vertical sectional view;

FIG. 14 schematically an embodiment of the device within a coffee machine;

FIG. 15 schematically rough an embodiment of the device with a removing of the contents from below; and

FIG. 16 schematically an embodiment of the device with a removing of the contents by water or compressed air.

### DETAILED DESCRIPTION OF THE INVENTION

In the following, examples of the invention are being shown, wherein same reference numerals are used within the figures for same elements of the different embodiments. In some Figures, the device is shown together with a capsule which contents are supposed to be separated from the package part by means of the device. It can be a capsule containing powder coffee, which is particularly known by the trademark Nespresso®. This capsule has an extraction side which is formed by a thin foil which is partly destroyed during the extraction of the beverage. The device is equally suitable for other capsules, for which a separation of capsule material and contents is desirable.

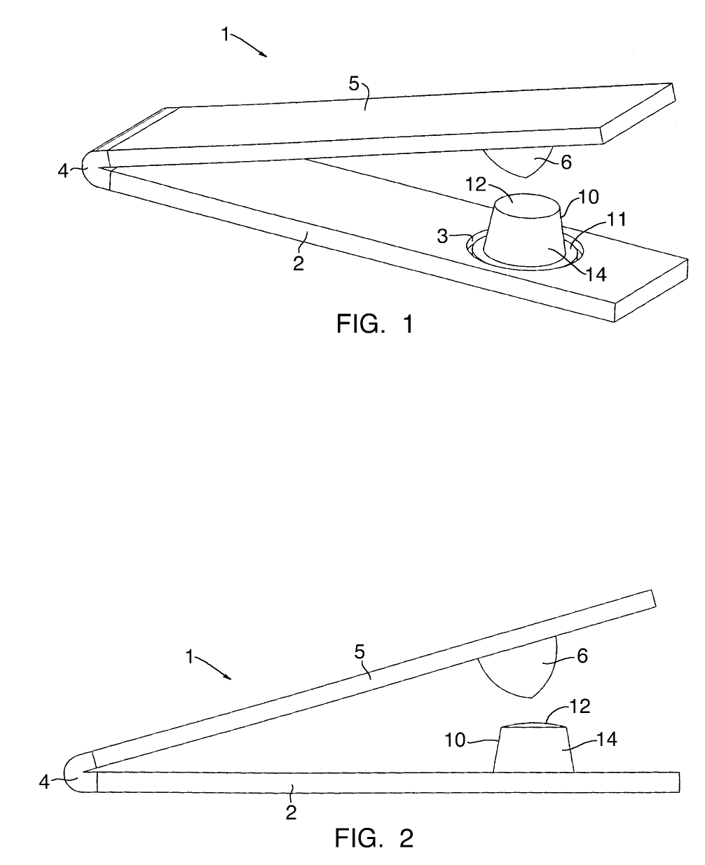

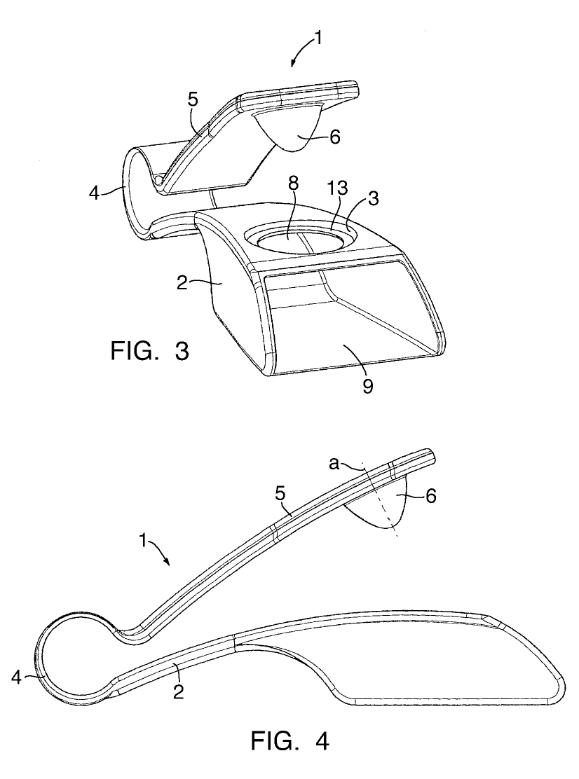

FIGS. 1-4 show first embodiments of a device 1, whereby the contents of the capsule are separated from the package by crunching the capsule, whereby the contents, particularly the coffee grounds, comes out of the already used capsule. In FIG. 1 it is evident that the device 1 has a base 2, wherein a support or rest, respectively, for the capsule 10 is provided. When the capsule is located within the rest 3, it comes to lie above an opening which allows the exit of the contents when the capsule is being crunched. This will be explained in the following by referring to FIG. 3. The capsule 10 normally lies within the rest 3 of the base 2 in such a way, that it comes to lie with its extraction side, not shown in the figure, through which the product extracted from the contents has flown out from the capsule, above the opening of the device. The crunching force then preferably acts upon the side 12 of the capsule 10 which is located opposite of the extraction side, which, in case of the Nespresso®-capsule, is the side by which water enters the capsule for the extraction.

In the example shown in FIGS. 1 and 2 an elongated element 5 is provided as crunching means, which could serve as plate-shaped crunching means as it is, which however preferably carries an especially formed crunching body 6. The element 5 and the base 2 are connected with each other by means of a joint 4 and can particularly be executed in one piece out of plastic or metal. For the crunching of the capsule 10, the element 5 is manually pivoted in the direction of the capsule 10, to apply a crunching force to the capsule. After the crunching, the element 5 is pivoted back upwards. This can be carried out just by manual actuation by the operator, supported by the reset force of the joint, if it is formed accordingly, and/or a return spring which is not shown in the figures but can additionally be provided, bringing the element 5 in the shown initial position again, wherein the crunched capsule 10 can be removed and wherein a further used capsule can be inserted into the device. Multiple supports or rests, respectively, for the simultaneous but separate separation of multiple capsules, particularly two capsules, could equally be provided.

FIG. 3 and FIG. 4 show a further embodiment, wherein the base 2 forms itself a cavity underneath rest 3. In the previous embodiment only the opening was formed in the base 2, such that the contents of the crunched capsule did exit from the base directly downwards. However, in the embodiment according to FIG. 3 and FIG. 4, the contents of the capsule enters the cavity 9 in the base 2, which forms a collecting space, through the opening 8. The contents or coffee grounds, respectively, can thus be disposed of easier. In FIG. 3 and FIG. 4 the capsule 10 is not shown, giving a better view of the rest 3 and the opening 8. The rest 3 forms a take-up for the capsule with an edge or rim 13, respectively, on which the capsule lies with its edge which can be a flange-like edge 11, as shown in FIG. 1. Also the embodiment of FIG. 3 and FIG. 4 has an upper element 5 as a crunching means, on which a crunching body 6 is preferably arranged. Here, the joint part 4 between base and upper element 5 is formed in a different way and generates a reset force for the returning of the element 5 into the base position after the crunching movement. The shown joint is particularly suitable for the manufacture of the device out of plastic. The function of the shown devices is such that the capsule 10, which used contents and in particular the coffee grounds is supposed to be separated from the rest of the capsule, is placed into the rest 3 above the opening 8. Thereafter, a crunching force is exerted by the arm and crunching body 5, 6 upon face 12 of the capsule, deforming the metal and thereby forcing the contents out of the capsule through its extraction side that has been partly destroyed and thus weakened during the extraction procedure in the machine for the extraction of the beverage or coffee machine, respectively. The contents of the crunched capsule fall through the opening 8 of the device into its container 9 in the case of the embodiment of FIGS. 3 and 4 and to an area below the base 2 in the embodiment of FIG. 1 and FIG. 2, i.e. on the surface of a table on which the device has been placed.

In the shown example, the crunching body 6 is part of a body of revolution with the rotational axis a (FIG. 4). This is a preferred embodiment which, in case of a suitable (adapted to the capsule to be separated) dimensioning of the crunching body, leads to a pressing in of the capsule wall 12 in the direction of the inside of the capsule, while the side wall 14 of the capsule remains at least partly, approximately in its previous shape. Nevertheless, the contents of the capsule are removed to a large extent by pressing in face 12 of the capsule. Thereby, a good separation between the metal of the capsule and the contents of the capsule can be reached, which allows that the metal part can be provided to the metal recycling without problems. This preferred way of crunching by the body 6 reduces the force to be exerted compared to a full crunching of the capsule. However, a stronger crunching inclusive destroying of the side walls can also take place with the crunching body and also a substantially complete crunching can occur.

In an embodiment, the cavity 9 can be formed in such a way, as to form a container, particularly a container which is closable at the front side of the base by means of a cover. The opening 8 can also be sealable, for example by positioning the crunching means by means of a support in such a way, that it closes the opening at least partly.

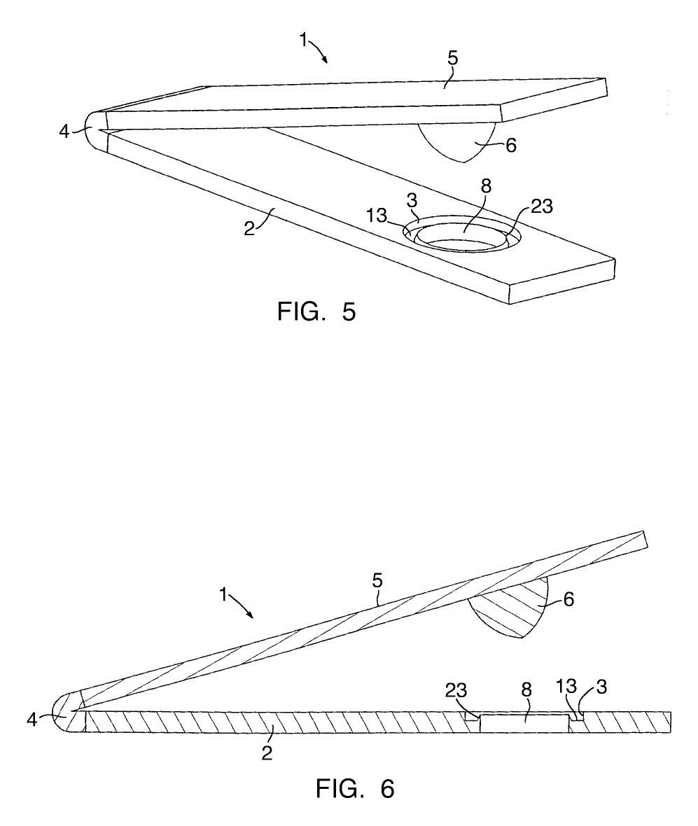

FIG. 5 and FIG. 6 show a further embodiment, for which a cutting means 23 for cutting the capsule on the extraction side is provided within the rest 3. This can enhance the crunching respectively the emptying of the contents. In the example, the cutting means is shown continuously circular, such that a round part of the capsule can be completely cut out. However, only a partly circular cutting means is preferred, such that the cut part of the capsule stays in contact with the rest of the capsule and is removed from the device with it and is not disposed of through the opening 8 together with the contents.

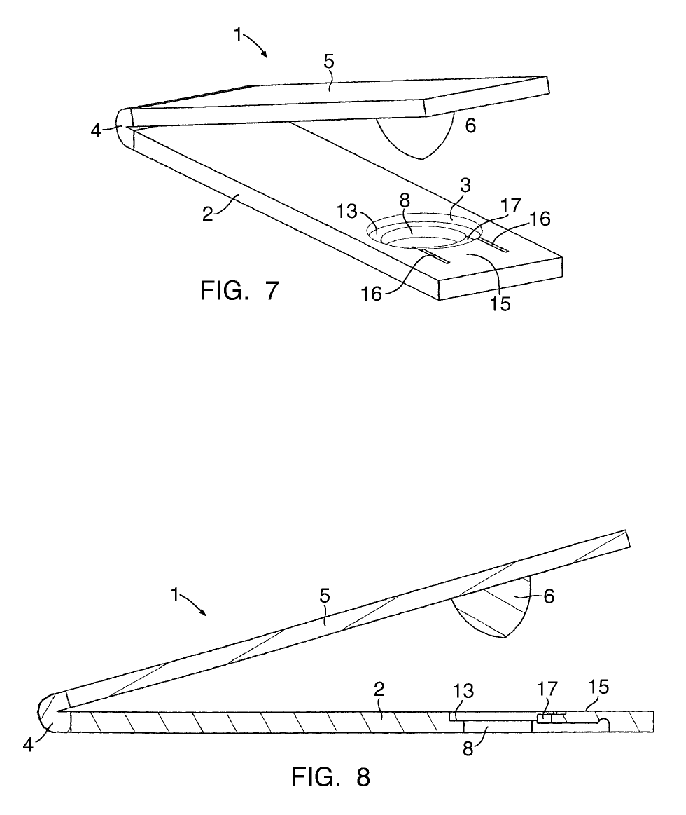

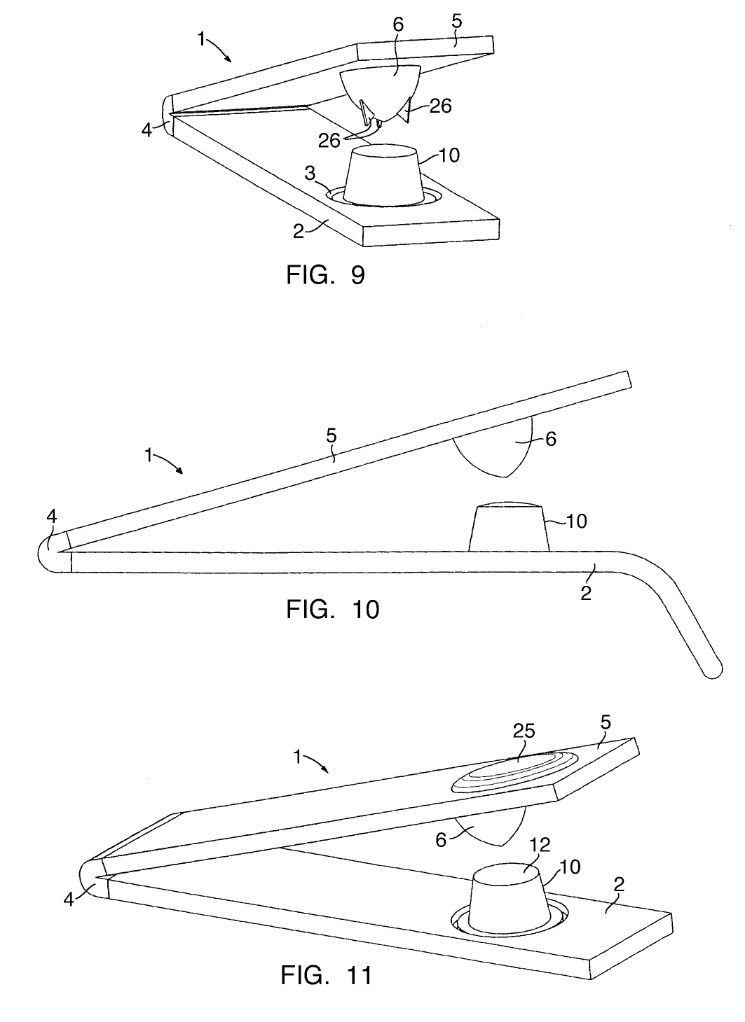

FIG. 7 and FIG. 8 show a spring means 15 which, in the shown example, is formed in one piece with the base 2 and has an elevated edge part 17 of the intake 3 being executed in a springy way by the cuts 16 in the base. This spring means counteracts the crunching force and ensures, after the ending of the crunching, that the emptied capsule is again slightly lifted out of the rest 3, by this facilitating the removal out of the rest 3. In an embodiment, the spring means 15 can be provided together with the already described cutting means 23 (combined with it or separately). FIG. 9 shows an embodiment, wherein the crunching body 6 has positioning means 26, which avoid a shifting and an evasion of the capsule 10 when crunching means 5, 6 acts upon the capsule. The positioning means 26 also can enhance the crunching and cause, in the example shown, a particularly stronger crunching of the side wall 14 of the capsule.

FIG. 10 shows a further embodiment, wherein the base 2 is formed curved, such that more space for the contents of the capsule is provided underneath the opening 8, but wherein no cavity 9 is provided for the contents.

FIG. 11 shows a further embodiment, wherein an actuator 25 is provided at the upper side of the crunching means, which is supposed to facilitate the manipulation and to avoid a glide off of the hand of the operator during the crunching of the capsule.

Beside the shown manual devices for the separation of the capsule and its contents, also motor driven devices can be provided and also such devices, which provide the separation of capsule and contents in a different way as by crunching. Such devices can particularly be provided within a coffee machine.

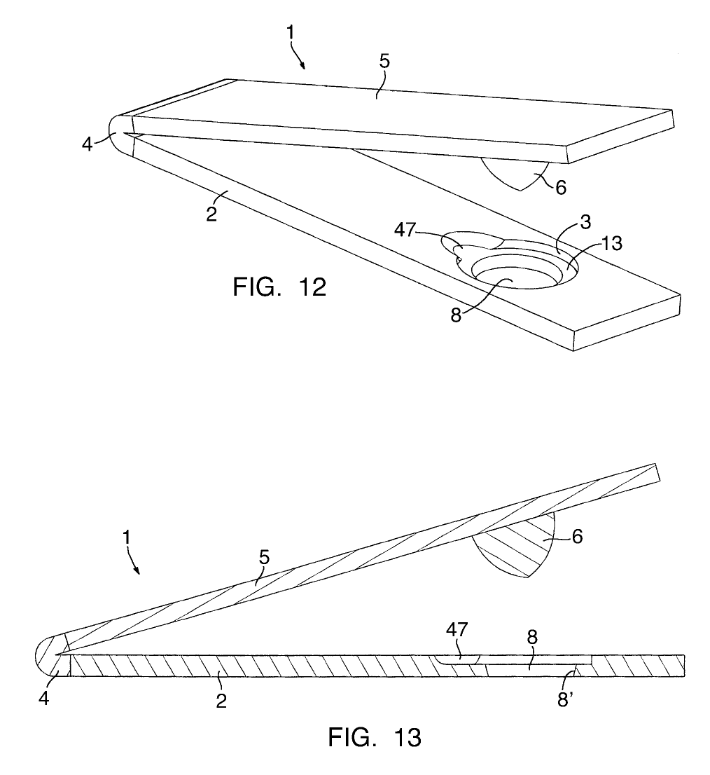

FIG. 12 shows a further embodiment in perspective view, which in FIG. 13 is shown in a sectional view. Thereby it is evident that the side wall 8′ of the opening 8 is conically shaped and enlarges towards the capsule and thus towards the rest 3. This facilitates the removal of the destroyed capsule, which may deform into the opening during destruction. Preferably, a removing aid is further provided, which can be the already described removal aid with spring means 15-17. Instead of or additionally to this embodiment of the removal aid, it can be executed in the form of a recess 47 which extends into the rest 3, facilitating the gripping of the destroyed capsule. Within the shown embodiment with a base and crunching means connected by means of a joint 4, the recess 47 is preferably arranged on the side of the intake showing towards the joint.

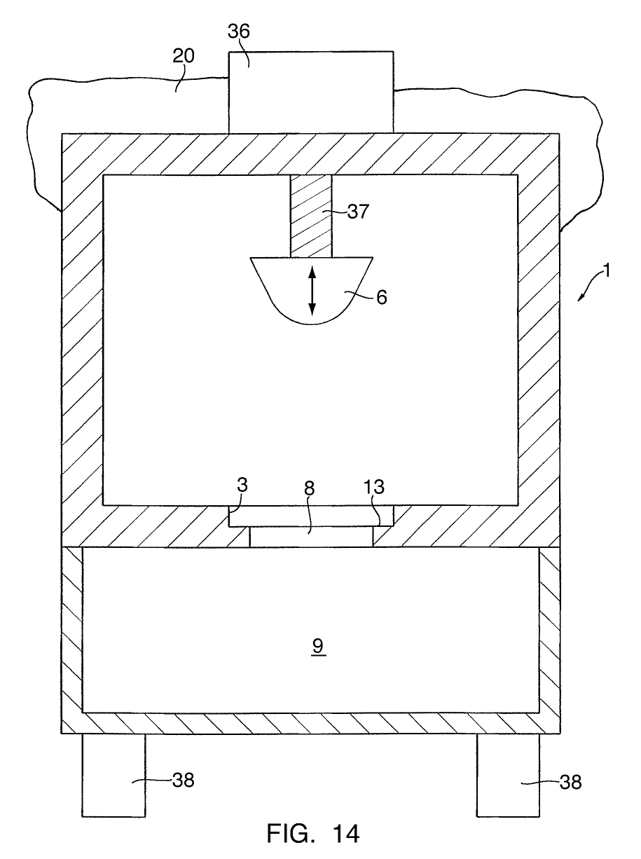

FIG. 14 shows in a schematic way only an embodiment, wherein the device is provided in a coffee machine 20 which is not explicitly depicted and of which only a casing part is denoted. This device also has a rest 3 for the capsule which is not shown. The device can be formed in such a way that the used capsule has to be inserted into the intake 3 manually, after the capsule has been removed from the coffee machine. But the device can as well work together with the capsule ejection mechanism of the coffee machine in such a way that after the extraction, the capsule is passed directly from this mechanism of the coffee machine into the rest 3. In the example shown, a crunching body 6 is now provided for crunching, being movable downwards, for example by means of a mandrel 37 driven by a motor 36, for the crunching of the capsule, and being movable back upwards after crunching. In this way, the capsule is crunched in a similar way as in the shown manual embodiments, here however by means of a linear movement instead of a pivoting movement of the crunching body, pressing out the contents of the capsule through the opening 8 into the cavity 9. The separation can additionally be enhanced by means which make the device 1 vibrate or which carry out a striking movement.

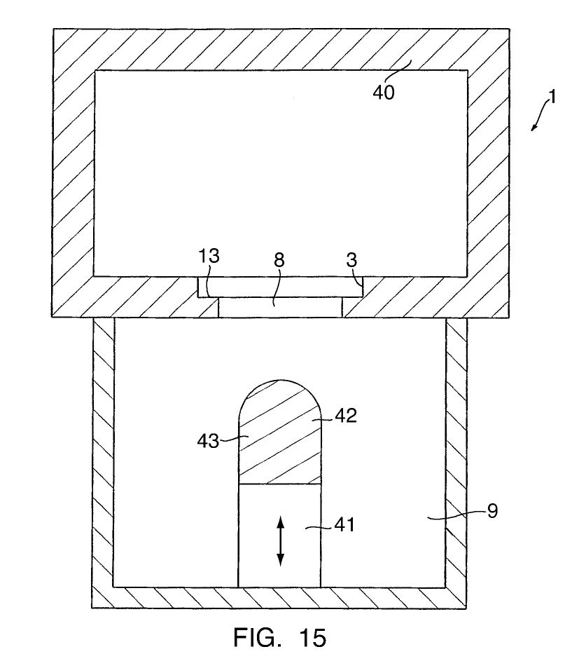

FIG. 15 shows in a rough schematic way an embodiment of the device 1, which can be provided in a coffee machine or separately as a stand alone device. Thereby, the capsule which is again not shown, is arranged on a rest 3, however it is held at the upper part, meaning at its face 12, by a limitation 40 which acts on the face 12 and is fixed for the separation. Limitation 40 can be removable for the insertion of the capsule 10 onto the rest 3. Also in this example, the capsule can be inserted manually or it is conveyed to the rest 3 by the coffee machine. For the separation of the contents of the capsule from the package, here an element 41 which is movably driven in the direction of the arrow is provided, which has a removal body 42 for the separation of the contents of the capsule, being pressed in from the extraction side of the capsule into the capsule. Thereby, the contents can come out of the capsule and fall into the container 9 through the opening 8, as soon as the removal body 42 is pulled out of the capsule again. It also can be provided that the driven removal body 42 can rotate around its longitudinal axis and it can have removal rips 43 which are arranged helically wound, feeding out the contents of the capsule. Also in this case vibration means or striking means can additionally be provided, enhancing the separation of the contents from the capsule.

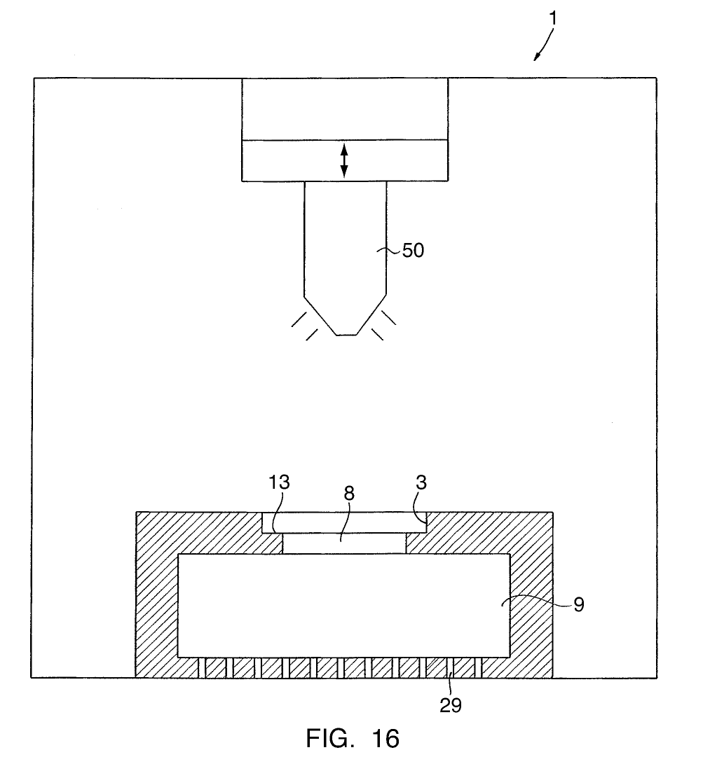

FIG. 16 shows an embodiment, wherein the capsule gets onto the rest 3 again, either manually or directly by the coffee machine, and wherein a water supply means 50 is inserted into the capsule from the top through the face 12 of the capsule, and subsequently the capsule is rinsed with water. Particularly, the cutting means 23 not shown here can be provided, cutting open the capsule on the extraction side. The mixture of water and contents then gets into the cavity 9 which has water outlet openings 29 at its bottom side, which are formed in such a way, that water can exit out of them downwards, however the contents remains in the cavity 9. This embodiment is preferably arranged within a coffee machine, wherein a supply for water under pressure is provided. In a modification of this embodiment, air can be blown into the capsule by the way shown or in a similar way, in order to blow out the contents, or air can be sucked out from the capsule in order to suck out its contents.

While there are shown and described presently preferred embodiments of the invention, it is to be distinctly understood that the invention is not limited thereto but may be otherwise variously embodied and practised within the scope of the following claims.

1. A device for the piece by piece separation of the contents and the package material of used capsules for the making of beverages, said device being adapted for at least partly destroying the capsules, particularly by compressing or crunching and/or cutting open and/or puncturing at least a part of the capsule.

2. The device according to claim 1, adapted for the crunching of a capsule above an opening of the device by means of crunching means in such a way, that at least a part of the contents of the capsule exits it and falls through the opening.

3. The device according to claim 2, comprising a base being provided with a rest which is shaped to hold the capsule in a predefined position above the opening, as well as a crunching means arranged above the base, through which the crunching force is applicable to the capsule which is in position on the rest of the base.

4. The device according to claim 3, wherein the rest is adapted for holding the capsule only along the edge of the capsule.

5. The device according to claim 1 including crunching means and wherein the crunching means is arranged pivotably around a swivel axis and in particular wherein the crunching means is arranged pivotably at a base of the device.

6. The device according to claim 5, wherein the crunching means is arranged at an arm which is formed in one piece with the base.

7. The device according to claim 1 including a crunching means and wherein the crunching means has a crunching body which is adapted to create a predetermined deformation of the capsule during crunching, and particularly has a crunching body which is substantially formed by a part of a body of revolution, particularly substantially a part of a paraboloid which is particularly intended to form a crater-shaped cavity in the capsule while the capsule side wall remains partly without deformation forming the crater wall.

8. The device according to claim 1 including a base with a rest for the capsule wherein a cutting means is provided at the base and particularly at the rest, which is intended for the forming of a partly or entirely circular cut in the capsule.

9. The device according to claim 1, comprising a removal aid which is intended for the ejection of the crunched capsule out of the intake, or which makes possible, as a recess, an easier access to the capsule.

10. The device according to claim 5, wherein a spring means counteracting the pivoting movement is provided.

11. The device according to claim 1 and including crunching means, wherein the crunching means are provided with at least one positioning element which is adapted to mutually adjust the position of capsule and crunching means at the beginning of the crunching.

12. The device according to claim 1, comprising a container for the reception of the contents separated from the package.

13. The device according to claim 1, wherein it is provided with a flat base for the positioning of the device on a surface and wherein an opening is arranged at a distance from the flat base, particularly by providing a cavity, particularly by providing a container, for the reception of the contents of at least a capsule, wherein the container is provided for particularly as a closable container.

14. The device according to claim 1, comprising an actuating means for the generation of a crunching force by hand or a motor driven actuating means for the generation of a crunching force.

15. The device according claim 1, which is such that the separation is made by a pulling out of the contents by means of a spiral conveying means and/or by means of a striking means or vibrating means or by means of a detergent for flushing out the contents with water or by means of a blowing means and/or a sucking means.

16. The device according to claim 1, wherein it is arranged in a coffee machine which is adapted for making coffee with coffee packaged in capsules.

17. Coffee machine for the extraction of coffee grounds from capsules containing coffee with a device according to claim 1.

18. A press, comprising a base having a rest which is adapted to hold a used capsule for making a beverage in a predefined position above an opening and which further comprises crunching means arranged above said base, by which a crunching force is exercisable on said capsule located in position on said base, for the separation of the contents of said capsule and of the package material of said capsules for making beverages, particularly of used capsules for making coffee which have a capsule body of metal, particularly aluminium, particularly wherein said press is adapted for the reception of the extraction side of said capsule onto the rest and for the exertion of the crunching force on the opposite side of said capsule.

19. A press according to claim 18, wherein the rest is adapted for holding said capsule only along its edge, and wherein the crunching means is arranged pivotably around a swivel axis and particular is arranged pivotably at said base, and in particular wherein the crunching means is arranged at an arm which is made in one piece with said base and in particular is made in one piece with said arm, and in particular wherein the crunching means is provided with a crunching body which is adapted to provide a predefined deformation of said capsule during its crunching, and in particular is provided with a crunching body which is adapted to form a round cavity into said capsule, and in particular wherein said crunching body is adapted to form a crater-shaped cavity in said capsule and wherein the capsule side walls remain as crater walls.

20. Press according to claim 19, wherein a cutting means is provided at said base and in particular at said rest, being intended for forming a partly or entirely circular cut in said capsule, and in particular wherein a removal aid for the crunched capsule is provided as eject element for the ejection of the crunched capsule from said rest, or wherein said removing aid is provided as a recess for allowing better gripping of the deformed capsule, and in particular wherein at least a positioning element is provided at said crunching means, being adapted to adjust the position of said capsule and said crunching means in relation to each other at the beginning of the crunching.

21. Press according to claim 18, comprising a container for the reception of the contents separated from the package, and in particular a press having flat base for the positioning onto a surface, wherein the opening is arranged at a distance from the base, in particular by forming a cavity, in particular a container which is in particular a closable container, for the reception of the contents of at least a capsule.

22. Method for separating the contents and the package material of used capsules for making beverages, particularly capsules of metal containing coffee, for which a single capsule is positioned with its extraction side above an opening and is at least partly destroyed, and particularly impinged and crunched from the side of intended water ingress into the capsule when extracting a beverage therefrom, by a crunching means, such that at least a part of the contents of the capsule exits out of it and falls through said opening.

23. Method according to claim 22, wherein the capsule is supported substantially only along its edge on a rest above the opening.

24. Method according to one of the claims 22, wherein the crunching is executed with a crunching body which is adapted to create a predefined deformation of the capsule during the crunching, and in particular such that a round cavity is pressed into the capsule at its water ingress position, particularly as a crater-shaped cavity in the capsule, whose side walls remain partly non-deformed as crater walls.

25. Method according to claim 22, wherein a partly or entirely circular cut is made in the sealing foil of the capsule, which is created at the extraction side of the used capsule before the crunching.

26. Method for separating the contents and the package material of used capsules for making beverages, particularly capsules of metal containing coffee, wherein the individual capsule is positioned with its extraction side above an opening and the separation is carried out by pulling out the contents by means of a spiral conveying means and/or by means of a striking means or vibrating means or by means of a detergent for flushing out the contents with water or by means of a blowing means and/or a sucking means.
